(19) United States
(12) Patent Application Publication
(10) Pub. No.: US 2026/0154765 A1
(43) Pub. Date: Jun. 4, 2026

(54) SYSTEM, METHOD, AND COMPUTER-READABLE MEDIUM FOR DATA PROCESSING

(71) Applicants: Getac Technology Corporation, Taipei City (TW); WHP Workflow Solutions, Inc., North Charleston, SC (US)

(72) Inventor: Muhammad Adeel, Edina, MN (US)

(21) Appl. No.: 19/371,199

(22) Filed: Oct. 28, 2025

Related U.S. Application Data
(60) Provisional application No. 63/727,196, filed on Dec. 3, 2024.

(51) Int. Cl. G06Q 50/26

(52) U.S. Cl. CPC G06Q 50/26

(57) ABSTRACT

A system includes a memory circuit configured to store input data, a storage circuit connected to the memory circuit, and a processor connected to the memory circuit and the storage circuit, the processor configured to perform following operation to the input data: receiving the input data in a hierarchical data format from an evidence system, parsing the input data to multiple elements, mapping the multiple elements into multiple fields in a data managing system according to a timestamp table, mapping the input data into an evidence management category according to the multiple fields to generate an evidence management data, and storing the evidence management data with the evidence management category into the storage circuit.

### RELATED APPLICATIONS

This application claims priority to and the benefits of U.S. Provisional Application No. 63/727,196 filed on Dec. 3, 2024, which is incorporated herein by reference in its entirety.

### TECHNICAL FIELD

The present disclosure relates to a system, a method, and a computer-readable medium for data processing. More particularly, the present disclosure relates to a system, a method, and a computer-readable medium for managing evidence data using data mapping and categorization.

### BACKGROUND

In many evidence services such as law enforcement, emergency medical service, and other similar services, a computer aided dispatch (CAD) system is widely implemented to record evidence of events. When evidence is collected from an in-car system, such as cameras, it is needed to manually assign a category to the evidence recorded. Therefore, the right retention policy for the evidence can be assigned. However, a wrong category may be assigned to critical evidence by manual mistakes, which results in early deletion, or no categorization assigned. In such cases, it is difficult to find evidence or to correct a wrong retention.

On the other hand, the evidence recorded in the CAD system is structured in an XML format. When XML data is imported to other system, a simple metadata mapping from CAD system to other system is hard to achieve due to XML data's hierarchical structure. As a result, a method for multi-level mapping from the CAD system to other systems as well as automatically assigning evidence to corresponding category is required, for accurately querying evidence data and to easily find the related evidence.

### SUMMARY

Consistent with embodiments of the present disclosure, a system is provided. The system comprises a memory circuit configured to store input data; a storage circuit connected to the memory circuit; and a processor connected to each of the memory circuit and the storage circuit, the processor configured to perform the following operation to the input data: receiving the input data in a hierarchical data format from an evidence system; parsing the input data to a plurality of elements; mapping the plurality of elements into a plurality of fields in a data managing system according to a timestamp table; mapping the input data into an evidence management category according to the plurality of fields to generate an evidence management data; and storing the evidence management data with the evidence management category into the storage circuit.

Consistent with embodiments of the present disclosure, a method is provided. The method comprises receiving the input data in a hierarchical data format from an evidence system; parsing the input data to a plurality of elements; mapping the plurality of elements into a plurality of fields in a data managing system according to a timestamp table; mapping the input data into an evidence management category according to the plurality of fields to generate an evidence management data; and storing the evidence management data with the evidence management category into the storage circuit.

Consistent with embodiments of the present disclosure, a non-transitory computer-readable medium is provided. The non-transitory computer-readable medium stores instructions which, when executed, cause at least one processor to perform operations for data processing, the operations comprising: storing input data; and receiving the input data from an evidence system to generate an evidence management data.

Furthermore, embodiments of the present disclosure may also include computer systems, apparatus, processes, and computer programs recorded on one or more computer storage devices, each configured to perform the operations disclosed in the present disclosure.

It is to be understood that the foregoing general description and the following detailed description are exemplary and explanatory only and are not restrictive of the disclosed embodiments.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a data managing system, illustrated in accordance with some embodiments of the present disclosure.

FIG. 2 is a flowchart diagram of a method for data processing, illustrated in accordance with some embodiments of the present disclosure.

FIG. 3 is a flowchart diagram of a method for operating a data managing system, illustrated in accordance with some embodiments of the present disclosure.

FIG. 4 is a flowchart diagram of a method for operating a search algorithm of a data managing system, illustrated in accordance with some embodiments of the present disclosure.

FIG. 5 is a schematic diagram of a data processing system, illustrated in accordance with some embodiments of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present disclosure belongs. It will be further understood that terms (such as those defined in commonly used dictionaries) should be interpreted as having a meaning consistent with its meaning in the related technology and/or the context of this specification and should not be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

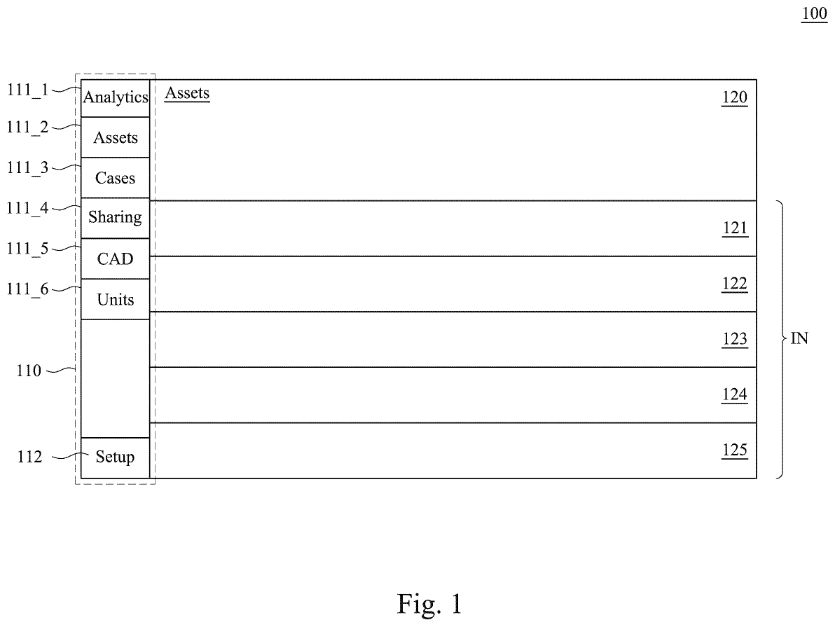

FIG. 1 is a schematic diagram of a data managing system 100, illustrated in accordance with some embodiments of the present disclosure. In some embodiments, FIG. 1 illustrates a user interface of the data managing system 100.

As illustratively shown in FIG. 1, the data managing system 100 includes a selection bar 110 and a selection interface 120. The selection bar 110 includes multiple sections 111_1-111_6 and a setup section 112. The selection interface 120 is configured to show multiple contents corresponding to the sections 111_1-111_6. In some embodiments, the sections 111_1-111_6 correspond to sections “Analytics”, “Assets”, “Cases”, “Sharing”, “CAD”, and “Units”, respectively.

For example, as shown in FIG. 1, the section 111_2 corresponding to the section “Assets” is selected. The content of the selection interface 120 corresponding to the section 111_2 includes multiple input data IN. In some embodiments, the input data IN includes multiple video data, such as multiple evidence data 121-125.

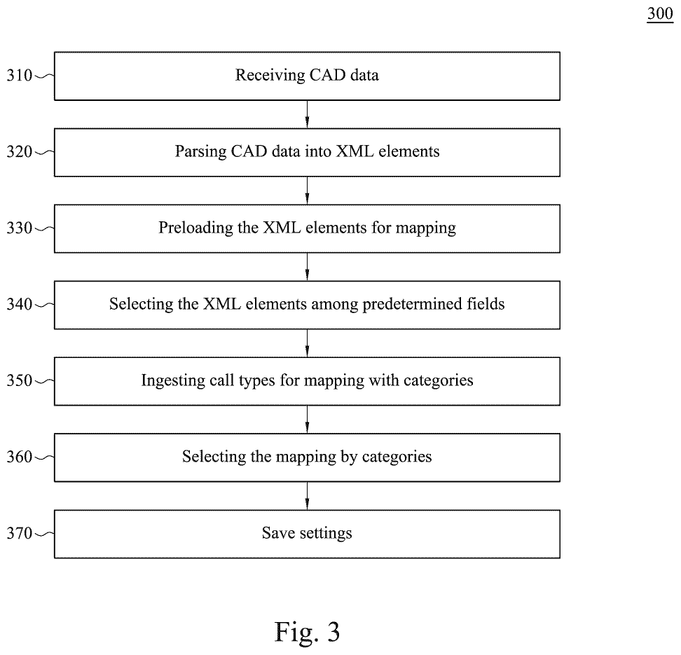

In some embodiments, the data managing system 100 is a software system configured to collect multiple input data IN from an evidence data system. The data managing system 100 further configured to map the evidence data 121-125 into assigned categories to generate the evidence management data MD. Further details regarding the operation of the data managing system 100 and the processing of the input data IN are discussed in FIG. 3 to FIG. 5 and corresponding paragraphs of the present disclosure.

In some embodiments, each of the input data IN is received from an evidence data system. The evidence data system can be implemented by a computer-aided dispatch (CAD) system. The CAD system is configured to collect multiple evidence data from in-car system, body-worn cameras, and is configured to import the evidence data into the data managing system 100. In such embodiments, the evidence data corresponds to the input data IN.

In some embodiments, the CAD system can be utilized in emergency services to streamline the management of emergency calls, such as 911 emergency telephone number, by recording incident details and tracking caller locations. The CAD system is further applied to dispatch appropriate responders, such as police, fire, or medical units, in real time. In some embodiments, the incident is referred to as an event or situation that has occurred.

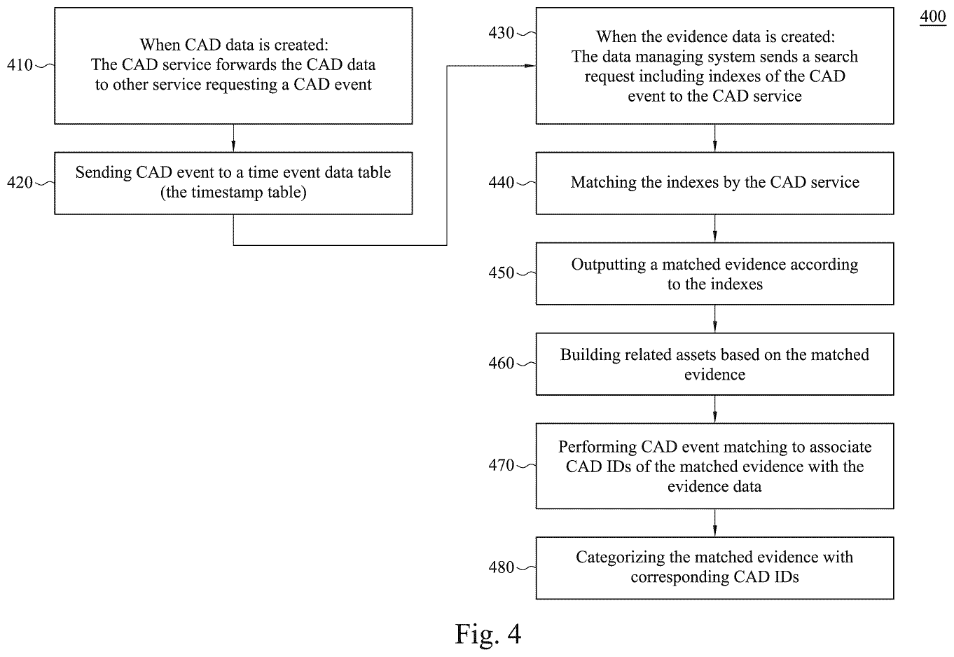

In some embodiments, a search algorithm AL is applied to the data managing system 100 when a CAD event and/or an evidence data is created. Specifically, the search algorithm AL is configured to perform a CAD search query when the CAD data and the evidence management data MD are collected. In some embodiments, when the search algorithm AL is performed, one or more related CAD data is collected and associated with the CAD data and the evidence management data MD according to the matched indices. Further details regarding the operation of the search algorithm AL and the CAD search query are discussed in FIG. 4 and the corresponding paragraphs of the present disclosure.

In some approaches, when a data managing system is operating, the evidence data is assigned manually to the right categories of the evidence. In these approaches, assigning the evidence data manually is a time-consuming process. In addition, the evidence data may be assigned to wrong categories, resulting in early deletion, or in some cases, no categorization of critical evidence. In some other approaches, it is hard to provide simple metadata mapping from the CAD system to the evidence data management system, when the input data is XML data due to its hierarchical in nature.

Compared to the approaches mentioned above, in some embodiments of the present disclosure, the data managing system 100 is able to perform a multi-level mapping of the input data IN, imported from the CAD system, into the evidence management data MD. The data managing system 100 automatically assigns categories to the input data IN according to the timestamp table by each of the timestamps. In some embodiments, the disclosed data managing system 100 is also able to identify how many officers, units, agencies, citizens, or cars were involved in an incident according to the evidence management data MD. This could be helpful to search related evidence data of the evidence management data MD.

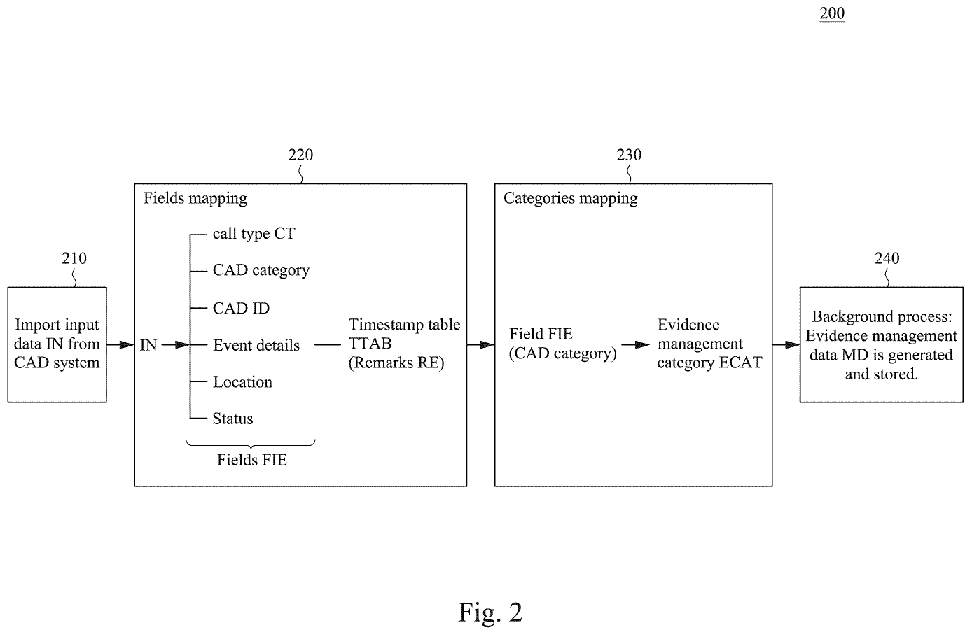

FIG. 2 is a schematic diagram of a method 200 for data processing, illustrated in accordance with some embodiments of the present disclosure. As illustratively shown in FIG. 2, the method 200 includes operations 210-240. In some embodiments, the method 200 is applied to the data managing system 100 for processing the input data IN. However, the method 200 of the present disclosure is not limited to be applied to the data managing system 100.

At the operation 210, the input data IN is imported from the CAD system to the data managing system 100.

Specifically, the data managing system 100 is configured to receive the input data IN having an eXtensible markup language (XML) format, exported from the CAD system. In some embodiments, the XML format is a hierarchical data format. The data managing system 100 performs the operation 220 after the operation 210 is performed.

In some embodiments, when a video is recorded from a video camera, the CAD system integrates the video into a CAD data having the XML format. The CAD data may be mapped to the CAD system on multiple levels according to timestamp records of CAD data. The CAD system automatically assigns category tag to the CAD data collected from users, units, or other sources. In such embodiments, the CAD data is the input data IN, and is referred to as the evidence data.

In some other embodiments, when the CAD system receives a video from a video camera, the CAD data may be integrated into the CAD system. The data managing system 100 is configured to import the XML data (that is, the input data IN) exported from the CAD system. The data managing system 100 is further configured to map multiple fields in (or from) the XML data to the evidence management data MD in the operations 220 and 230.

At the operation 220, the data managing system 100 performs a fields mapping to the input data IN.

Specifically, the input data IN includes multiple fields FIE, the fields FIE include, for example, a call type CT, CAD IDs, event details, location, and status. However, the present disclosure is not limited to these fields. The data managing system 100 is configured to parse the fields FIE of the input data IN from the XML format into separated fields as XML elements. In some embodiments, each of the call type CT, the CAD IDs, the event details, location, and the status corresponds to a value of number and/or a string of text.

For example, when the evidence data 121 indicates a traffic accident, the event details of the fields FIE are marked as “traffic accident”. At this moment, the input data IN is assigned with specific fields, including the call type CT, CAD IDs, location, and status, such as “accident”, “123456”, “intersection”, and “reported”, respectively. More specifically, when the evidence data 121 indicates a traffic accident that occurred at an intersection and the traffic accident has been reported to a police office, the data managing system 100 assigns the values of “accident”, “intersection”, and “reported” to the call type CT, the location, and the status of the fields FIE, respectively.

In some embodiments, the event details of the fields FIE include a timestamp table TTAB. The timestamp table TTAB includes multiple remarks RE. Each of the remarks RE corresponds to an individual timestamp T in the timestamp table TTAB. In some embodiments, the remarks RE are represented by a value of number and/or a string of text, and the remarks RE can be predetermined or predefined.

In some embodiments, the timestamp table TTAB is mapped with line-by-line details of an incident, and the timestamp T is referred to as date and time of the incident happened. Specifically, the timestamp T indicates a time point when the corresponding remarks RE is occurred.

In the example described above, when the evidence data 121 indicates the traffic accident, a first timestamp T1 in the timestamp table TAB may include one of the remarks RE, such as “Officer assigned”, “First Unit Arrived”, and “Dispatcher Remark”. Similarly, a second timestamp T2 after the first timestamp T1 may include one of another remarks RE, such as “Officer Arrived”, “Second Unit Arrived”, and “Dispatcher Remark”. However, the present disclosure is not limited to the example of remarks RE described above.

In some embodiments, when the operation 220 is performed, a user interface is provided for a user to map the fields FIE of the input data IN (that is, the XML data) to categories in the data managing system 100. The data managing system 100 performs the operation 230 after the operation 220 is performed.

At the operation 230, the data managing system 100 performs a categories mapping to the input data IN. In some embodiments, the input data IN may also include multiple CAD categories. The evidence data 121-125 corresponds to one of the CAD categories.

In some embodiments, when the input data IN includes CAD categories, the data managing system 100 is configured to assign the CAD categories into the evidence management category ECAT. For example, when the evidence data 121 indicates a CAD category of “accident”, the data managing system 100 assigns the evidence data 121 to the evidence management category ECAT indicating “accident”. In this circumstance, the evidence management category ECAT shares a same category with the CAD category. In these embodiments, the CAD categories can be provided or adjusted by user, such as, customer, officer, units, or a CAD vendor. The data managing system 100 performs the operation 240 after the operation 230 is performed.

In some embodiments, when the input data IN does not include CAD categories, the data managing system 100 is configured to assign the input data IN into an evidence management category ECAT based on a call type CT from the input data IN. For example, when the call type CT the evidence data 121 indicates “accident”, the data managing system 100 assigns the evidence data 121 to the evidence management category ECAT indicating “accident”. At this moment, the value of the call type CT is mapped to the evidence management category ECAT indicating “accident”. In some embodiments, the call type CT can be represented by a value of number and/or a string of text. In some embodiments, the values of the call type CT include, for instance, “Traffic Stop”, “medical”, “fire”, “burglary”, “accident”, “alarm”, and other similar texts representing a situation. However, the present disclosure is not limited to these values.

At the operation 240, the data managing system 100 performs a background process.

Specifically, the background process is referred to as an execution of ingesting the input data IN, parsing the input data IN, storing the input data IN into a database, and/or applying new categories to the input data IN based on the call type CT, when the input data IN does not include the CAD category. After the background process is performed, the data managing system 100 generates an evidence management data MD according to the evidence management category ECAT, and stores the evidence management data MD into storage of the data managing system 100.

In some embodiments, the background process enables the data managing system 100 to handle large volumes of CAD data efficiently and accurately. For instance, when CAD/XML data is ingested, the data managing system 100 may automatically parse the data into structured XML elements, which are then preloaded for easy selection and mapping. The data managing system 100 completes the method 200 after the operation 240 is performed.

In some embodiments, even though the incident has occurred for a longer period, an individual officer may only be involved and recorded the incident for a short amount of time, the disclosed data managing system 100 and the method 200 enable a user, an officer, or a unit to accurately query or search user-specific data using a timestamp table TTAB.

In some embodiments, the method 200 of the present disclosure may be related to not only a flag data mapping, but also a hierarchical data mapping.

In some embodiments, the parsing process in the method 200 involves extracting relevant information such as unit identifiers, timestamps, officer details, and geographic coordinates. Each of this relevant information is crucial for accurate evidence categorization and retrieval. Additionally, the disclosed data managing system 100 utilizes advanced algorithms to match CAD events with corresponding evidence records, enhancing the precision of the categorization process. Further details regarding the advanced algorithms are discussed in FIG. 4 and the corresponding paragraphs of the present disclosure. The data managing system 100 can also support bulk uploads, allowing multiple CAD calls to be ingested and mapped simultaneously, thereby streamlining the workflow for users. Once the data is stored in the database, the evidence system can apply predefined categories based on call type CT, ensuring that each piece of evidence is appropriately classified.

Furthermore, the data managing system 100 is able to provide a user interface that enables users to manually adjust mappings and categories as needed. This user interface includes features such as real-time synchronization with the CAD system, advanced filtering options, and the ability to save custom settings for future use. By automating the background process in the operation 240 and offering flexible user controls, the data managing system 100 enhances the overall efficiency and accuracy of evidence management, facilitating faster and more informed decision-making.

FIG. 3 is a flowchart diagram of a method 300 for operating the data managing system 100, illustrated in accordance with some embodiments of the present disclosure. As illustratively shown in FIG. 3, the method 300 includes operations 310-370.

At the operation 310, the data managing system 100 receives the input data IN from the CAD system.

Specifically, an XML file is exported from the CAD system and is uploaded to the data managing system 100 as the input data IN. The data managing system 100 performs the operation 320 after the operation 310 is performed.

At the operation 320, the data managing system 100 parses the input data IN (that is, the CAD data) into multiple XML elements.

Specifically, after the input data IN is received by the data managing system 100, the data managing system 100 is configured to parse the input data IN having the XML format into XML elements. In some embodiments, the XML elements correspond to the fields FIE and corresponding values of the fields FIE as discussed in FIG. 2.

For example, the input data IN is parsed into different field FIE, such as the CAD categories, the call type CT, the CAD IDs, the event details, the location, and the status. The data managing system 100 performs the operation 330 after the operation 320 is performed.

At the operation 330, the data managing system 100 preloads the XML elements for mapping.

Specifically, the data managing system 100 is configured to preload each of the fields FIE and corresponding values of the fields FIE on the user interface, such as the selection interface 120 shown in FIG. 1, for selection for mapping. The data managing system 100 performs the operation 340 after the operation 330 is performed.

At the operation 340, the data managing system 100 selects the XML elements among predetermined fields.

Specifically, the data managing system 100 is further configured to provide users to select one or more XML elements according to one or all of the fields FIE on the user interface.

For example, when the predetermined fields include the call type CT, the CAD ID, and the Location, the values of the XML elements corresponding to the call type CT, the CAD ID, and the Location are selected. The data managing system 100 performs the operation 350 after the operation 340 is performed.

At the operation 350, the data managing system 100 ingests each of the call types CT corresponding to the XML files for mapping with categories.

Specifically, when one or more XML elements are selected, the data managing system 100 is configured to ingest each of the call types CT which corresponds to the one or more XML selected XML elements for mapping with the evidence management categories ECAT. The data managing system 100 performs the operation 360 after the operation 350 is performed.

In some embodiments, multiple CAD calls for mapping with categories can be ingested using bulk upload.

At the operation 360, the data managing system 100 selects the mapping to map the input data IN according to the evidence management categories ECAT.

Specifically, the data managing system 100 maps the input data IN having the predetermined fields to the evidence management data MD according to the evidence management categories ECAT.

For example, when the predetermined field of “Car accident” is selected by a user, the input data IN having the fields FIE of “Car accident” is mapped into the category “Accident” of the evidence management categories ECAT. The data managing system 100 performs the operation 370 after the operation 360 is performed.

At the operation 370, the data managing system 100 is configured to save the settings. The settings include the predetermined fields selected from the fields FIE and the evidence management data MD generated according to the predetermined fields.

In some embodiments, the settings can be saved and stored automatically by the data managing system 100. In some other embodiments, the settings can be saved by user in the data managing system 100 through the user interface. In addition, the user can further store the CAD calls with the corresponding categories, such as the evidence management categories ECAT, into a database of the data managing system 100.

In some embodiments, the data managing system 100 also supports real-time synchronization with the CAD system to ensure that the latest data is available for analysis and mapping. This synchronization can be achieved by implementing application programming interfaces (APIs) on the data managing system 100. The APIs facilitate seamless data exchange between the CAD system and the data managing system 100. The data managing system 100 automatically update the database with new CAD data and associated metadata as they are generated, reducing the need for manual operation and ensuring data consistency. Additionally, the data managing system 100 is able to provide advanced filtering and search capabilities within the user interface, allowing users to quickly locate and map relevant CAD data to the evidence management data MD. This real-time integration can enhance the efficiency and accuracy of the evidence management process, enabling a faster and more informed decision-making.

FIG. 4 is a flowchart diagram of a method 400 for operating the search algorithm AL of the data managing system 100, illustrated in accordance with some embodiments of the present disclosure. As illustratively shown in FIG. 4, the method 400 includes operations 410-480.

At the operation 410, when the CAD data is created, the CAD service forwards the CAD data to other service requesting a CAD event.

Specifically, when the CAD system receives a video recorded from a camera, the CAD data is created. When the CAD data is created, the CAD service (that is, the CAD system) forwards the CAD data to other services to request one or more CAD events that are related to the CAD data. In some embodiments, the other services include evidence service, case service, or other similar official services. After the CAD event is received, the CAD system performs the operation 420.

At the operation 420, the CAD events are sent to a time event data table (the timestamp table TTAB) by the CAD system. For example, when the CAD system receives the CAD events, the CAD system records the CAD events into the timestamp table TTAB with multiple timestamps T.

In some embodiments, the CAD search query is applied when one or more CAD events are created. Since some of the CAD events may substantially span over many days, keeping all of the CAD events across these days is crucial. The CAD data generated during preceding days of the CAD event may be kept and sent to fields of “off-hours” or “infrequently” in a time event data table. In this way, all CAD data related to the same CAD event may be tagged, or flagged that indicates the CAD information being sent is maintained.

At the operation 430, when the evidence data is created, the data managing system 100 sends a search request, including multiple indices related to the CAD events, to the CAD service.

For example, when the evidence management data MD is generated by performing the method 200, the data managing system 100 further sends a search request to the CAD service. The search request includes the indices related to the CAD events.

In some embodiments, the indices of the search request may include one or more of a unit and a date range that indicates the start time and end time of recorded assets, that is, the CAD events. In some embodiments, the purpose of sending the search request is to locate a CAD ID of some other CAD events that correspond to the evidence management data MD. The data managing system 100 performs the operation 440 after the operation 430 is performed.

At the operation 440, the CAD service matches the indices with other CAD events.

Specifically, the CAD service matches each of the CAD IDs, an officer who recorded or is the most relevant to the CAD event, units with aggregated responding times, CAD categories, and GPS (geographic location) of the CAD event with other CAD events from the other services. The other services include evidence service, case service, or other similar official services as mentioned at the operation 410. The data managing system 100 performs the operation 450 after the operation 440 is performed.

At the operation 450, the CAD service outputs a matched evidence ME according to the indices.

Specifically, when some other CAD events are matched with the indices, the CAD service outputs the CAD events that are matched with the indices as the matched evidence ME. The matched evidence ME includes each of the other CAD events that are matched with the indices. The data managing system 100 performs the operation 460 after the operation 450 is performed.

At the operation 460, the data managing system 100 builds related assets based on the matched evidence.

Specifically, when the matched evidence ME is generated, the data managing system 100 builds a set of related assets. The related assets include the CAD data corresponding to the evidence management data MD and the CAD events corresponding to the matched evidence ME.

In some embodiments, the building process includes fetching related assets of the units involved in the CAD events corresponding to the matched evidence ME, creating and/or updating a related asset map for relevant evidences, and/or saving the related asset map in a database. In some embodiments, the related assets are marked as “relation” with the CAD event based on CAD events of to the matched evidence ME.

For example, when the matched evidence ME includes multiple related CAD events, and the evidence management data MD includes CAD data corresponding to a CAD event, the data managing system 100 builds a set S of the related assets including each of the CAD events. The data managing system 100 performs the operation 470 after the operation 460 is performed.

At the operation 470, the data managing system 100 performs a CAD event matching to associate CAD IDs of the matched evidence ME with the evidence management data MD.

Specifically, the data managing system 100 associates the CAD IDs of the CAD events in the matched evidence ME with the evidence management data MD. The data managing system 100 performs the operation 480 after the operation 470 is performed.

At the operation 480, the data managing system 100 categorizes the matched evidence ME with corresponding CAD IDs.

Specifically, in addition to associating CAD IDs, the data managing system 100 may provide new categories. Under this circumstance, the matched evidence ME is categorized with the CAD IDs, and the CAD events corresponding to the CAD IDs can further be categorized according to the evidence management category ECAT.

In some circumstances, if the received CAD ID is associated with the matched evidence ME, the data managing system 100 may send the received CAD ID to the CAD service to fetch some other matched CAD events and related data.

In some other circumstances, if the received CAD ID is not associated with the matched evidence ME, the data managing system 100 may send parameters, such as the unit or the date range, etc., to the CAD service.

In some embodiments, a CAD search endpoint END is determined according to multiple parameters, such as a date range, a unit's ID, a badge number of an officer, and/or a user ID. At least one of the parameters is required for determining the CAD search endpoint END. The search algorithm AL requires the CAD search endpoint END to perform searching. The functioning of the search algorithm AL depends on the parameters passed to the CAD search endpoint END. After performing the search algorithm AL, the CAD search endpoint END may have a maximum number of returned results, for example, five CAD results, based on a best match.

In some embodiments, the data managing system 100 may also incorporate advanced analytics and machine learning algorithms to enhance the CAD matching process. By analyzing historical data and patterns, the data managing system 100 can predict and suggest potential matched evidence ME for new CAD data with higher accuracy. This predictive capability can be particularly useful in complex scenarios where multiple units and officers are involved, and the events span extensive geographic areas and time frames. Additionally, the data managing system 100 can continuously learn and improve from new data inputs, refining its matching algorithms to adapt to evolving operational contexts. This dynamic approach ensures that the data managing system 100 remains robust and reliable, providing precise and timely associations between evidence and CAD events.

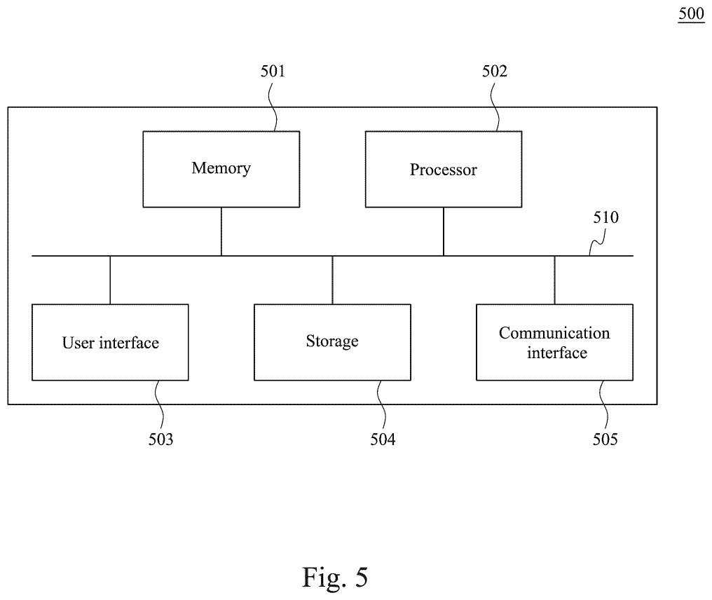

FIG. 5 is a schematic diagram of a data processing system 500, illustrated in accordance with some embodiments of the present disclosure. In some embodiments, the data managing system 100 is implemented on the data processing system 500.

As illustratively shown in FIG. 5, the data processing system 500 includes a memory circuit 501, at least one processor 502, a user interface 503, a storage circuit 504, and a communication interface 505. Each of the memory circuit 501, the at least one processor 502, the user interface 503, the storage circuit 504, and the communication interface 505 is connected to a bus 510 to transmit data. In some embodiments, the memory circuit 501 stores instructions which, when executed, cause the at least one processor 502 to perform operations for data processing as the methods 200, 300, and 400 described above. In some embodiments, the data managing system 100 shown in FIG. 1 is illustrated and implemented by the user interface 503.

Referring to FIG. 1 to FIG. 4, in some embodiments, the memory circuit 501 is configured to temporarily store the input data IN. The processor 502 is configured to receive the input data IN from the memory circuit 501 through the bus 510 and perform the fields mapping and the categories mapping as shown in the operations 220 and 230. The processor 502 is further configured to perform the background process as shown in operation 240 to generate the evidence management data MD. The evidence management data MD is transmitted to and stored in the storage circuit 504 by the processor 502.

In some embodiments, the user interface 503 is configured to provide an interface for users to provide instructions that operate with the data managing system 100. In some embodiments, the communication interface 505 is configured to transmit search request and CAD data to other services. The communication interface 505 is further configured to receive the related CAD events and CAT data from other services as illustrated in the operations 410-450.

Another aspect of the disclosure is directed to a non-transitory computer-readable medium, such as the memory circuit 501 of the data processing system 500, storing instructions which, when executed, cause one or more processors, such as the at least one processor 502, to perform the methods 200, 300, and 400 discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted. Furthermore, while some of the exemplary embodiments of the computerized methods were described using Java language or C to illustrate exemplary scripts and routines, the disclosed methods and systems may be implemented using alternative languages. The disclosed embodiments may use one or multiple programming languages in addition to Java or C. For example, the disclosed embodiments may also be implemented using Python, C++, C #, R, Go, Swift, Ruby, and/or their combinations.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

What is claimed is:

1. A system, comprising:
a memory circuit configured to store input data;
a storage circuit connected to the memory circuit; and
a processor connected to the memory circuit and the storage circuit, the processor configured to perform the following operation to the input data:
receiving the input data in a hierarchical data format from an evidence system;
parsing the input data to a plurality of elements;
mapping the plurality of elements into a plurality of fields in a data managing system according to a timestamp table;
mapping the input data into an evidence management category according to the plurality of fields to generate an evidence management data; and
storing the evidence management data with the evidence management category into the storage circuit.

2. The system of claim 1, wherein:
the hierarchical data format is implemented by an eXtensible Markup Language (XML) data format, and
the evidence system is implemented by a computer-aided dispatch (CAD) system.

3. The system of claim 1, wherein the plurality of fields comprises a call type, the call type includes a value of a string of text.

4. The system of claim 1, wherein the timestamp table comprises a plurality of timestamps.

5. The system of claim 4, wherein any of the timestamps indicates a time point when an incident of one of the fields occurs.

6. A method, comprising:
receiving input data in a hierarchical data format from an evidence system;
parsing the input data to a plurality of elements;
mapping the plurality of elements into a plurality of fields in a data managing system according to a timestamp table;
mapping the input data into an evidence management category according to the plurality of fields to generate an evidence management data; and
storing the evidence management data with the evidence management category into a storage circuit.

7. The method of claim 6, wherein
the hierarchical data format is implemented by an eXtensible Markup Language (XML) data format, and
the evidence system is implemented by a computer-aided dispatch (CAD) system.

8. The method of claim 6, wherein the plurality of fields comprises a call type, the call type includes a value of a string of text.

9. The method of claim 6, wherein the timestamp table comprises a plurality of timestamps.

10. The method of claim 9, wherein any of the timestamps indicates a time point when an incident of one of the fields occurs.

11. A non-transitory computer-readable medium storing instructions which, when executed, cause at least one processor to perform operations for data processing, the operations comprising:
storing input data having a hierarchical data format; and
receiving the input data from an evidence system to generate an evidence management data.

12. The non-transitory computer-readable medium of claim 11, wherein the operations further comprise:
parsing the input data to a plurality of elements;
mapping the plurality of elements into a plurality of fields in a data managing system according to a timestamp table;
mapping the input data into an evidence management category according to the plurality of fields to generate the evidence management data; and
storing the evidence management data with the evidence management category into a storage circuit.

13. The non-transitory computer-readable medium of claim 12, wherein the operations further comprise:
providing an interface for users to provide instruction that operate with the data managing system; and
transmitting a search request and the input data to other services.

14. The non-transitory computer-readable medium of claim 12, wherein;
the hierarchical data format is implemented by an eXtensible Markup Language (XML) data format, and
the evidence system is implemented by a computer-aided dispatch (CAD) system.

15. The non-transitory computer-readable medium of claim 12, wherein the plurality of fields comprises a call type, the call type includes a value of a string of text.

16. The non-transitory computer-readable medium of claim 12, wherein the timestamp table comprises a plurality of timestamps.

17. The non-transitory computer-readable medium of claim 16, wherein any of the timestamps indicates a time point when an incident of one of the fields occurs.

18. The non-transitory computer-readable medium of claim 13, wherein the operations further comprise:
forwarding the input data to the other services requesting a CAD event, and
sending the CAD event to the timestamp table.

19. The non-transitory computer-readable medium of claim 18, wherein the operations further comprise:
sending a search request including a plurality of indices to the evidence system,
receiving one or more matched indices form the evidence system, and
building a plurality of related assets according to the one or more matched indices.

20. The non-transitory computer-readable medium of claim 19, wherein the operations further comprise:
performing a CAD event matching to associate the one or more matched indices with the input data, and
categorizing the one or more matched indices into a plurality of categories corresponding to the evidence management data.
